(19) United States
(12) Patent Application Publication
(10) Pub. No.: US 2013/0141531 A1
(43) Pub. Date: Jun. 6, 2013

(54) COMPUTER PROGRAM PRODUCT, COMPUTER READABLE MEDIUM, COMPRESSION METHOD AND APPARATUS OF DEPTH MAP IN 3D VIDEO

(71) Applicants: Jih-Sheng Tu, Yilan County (TW); Jung-Yang Kao, Pingtung County (TW)

(72) Inventors: Jih-Sheng Tu, Yilan County (TW); Jung-Yang Kao, Pingtung County (TW)

(73) Assignee: Industrial Technology Research Institute, Hsinchu (TW)

(21) Appl. No.: 13/351,227

(22) Filed: Jan. 17, 2012

(30) Foreign Application Priority Data
Dec. 2, 2011 (TW) 100144379

(51) Int. Cl. H04N 13/00

(52) U.S. Cl. 348/43; 348/E13.062

(57) ABSTRACT

A compression method and apparatus of depth map in a 3D video are provided. The compression apparatus includes an edge detection module, a homogenizing module, and a compression encoding module. An edge detection is performed on a depth map of a frame in the 3D video. When at least one macroblock in the frame with no object edge passing through is found, a homogenizing processing is performed on the at least one macroblock. And then the depth map is encoded. Therefore, data quantity might be decreased when the depth map is compressed and encoded according to the present disclosure.

### CROSS-REFERENCE TO RELATED APPLICATION

This application claims the priority benefit of Taiwan application serial no. 100144379, filed on Dec. 2, 2011. The entirety of the above-mentioned patent application is hereby incorporated by reference herein and made a part of this specification.

### BACKGROUND OF THE DISCLOSURE

1. Field of the Disclosure

The disclosure relates to a three dimensional (3D) video technology. Particularly, the disclosure relates to a compression method of depth map of a 3D video.

2. Description of Related Art

In recent years, with resurgence of a three-dimensional (3D) wave, various audio and video entertainment products catch such trend to put out digital contents such as 3D movies and 3D games, etc., and new products of consumer electronic products that support viewing and self-producing the 3D content are also developed, such as 3D screens, 3D cameras and 3D video camera, etc., and all major consumer electronics manufacturers want to seize the opportunities. However, in production of the 3D videos, there is no universal video compression standard, which may cause incompatibility of the videos, i.e. the videos probably cannot be played on every terminal equipment, which may cause obstructions for promotion of the 3D digital contents.

A moving picture experts group (MPEG) is developing a new 3D video compression standard, according to such standard, it is desired to only use color texture images and depth maps of grayscales of 2 or 3 frames to generate virtual images of a plurality of frames, so as to achieve a multi-view viewing effect. The texture images are nature images captured by a video camera, and the depth map is generally a grayscale image of 8 bits, in which each pixel value represents a distance between an object and the video camera, i.e. the depth map presents a relative relationship of spatial coordinates of the objects, which is not certainly related to the color of the object.

FIG. 1 is a block schematic diagram of using texture images and depth maps of 3 frames to form multi-view images of 9 frames. Referring to FIG. 1, each of the texture images is referred to as a view, and V1, V2, . . . , V9 are used to represent the views, and based on a depth image based rendering (DIBR) algorithm, the texture images and depth maps of 3 frames are used to form 9 views. So that when an observer views from different positions, for example, a position 1 (Pos1), a position 2 (Pos2) or a position 3 (Pos3), etc., as long as a left eye and a right eye of the observer receive the corresponding texture image, the multi-view function is implemented. Namely, regardless of a viewing angle, the 3D effect is achieved as long as the left eye and the right eye respectively receive the corresponding images.

### SUMMARY OF THE DISCLOSURE

An exemplary embodiment of the disclosure provides a compression method of depth map in a three-dimensional (3D) video, which includes following steps. An edge detection is performed on a depth map of a frame in the 3D video. When at least one macroblock in the frame with no object edge passing through is found, a homogenizing processing is performed on the at least one macroblock. Then, the depth map is encoded.

An exemplary embodiment of the disclosure provides a compression apparatus of depth map in a 3D video. The compression apparatus includes an edge detection module, a homogenizing module, and a compression encoding module. The edge detection module performs an edge detection on a depth map of a frame in the 3D video. The homogenizing module is coupled to the edge detection module, and when a macroblock in the frame with no object edge passing through is found or the macroblock does not belong to an edge area, the homogenizing module performs a homogenizing processing on the macroblock. The compression encoding module is coupled to the homogenizing module and encodes the homogenized depth map.

An exemplary embodiment of the disclosure provides a computer readable medium storing a program, and when a computer loads and executes the program, the aforementioned compression method is implemented.

An exemplary embodiment of the disclosure provides a computer program product, and when a computer loads and executes the computer program, the aforementioned compression method is implemented.

According to the above descriptions, the homogenizing processing is performed on the macroblock in the non-edge area or the macroblock with no object edge passing there through.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block schematic diagram of using texture images and depth maps of 3 frames to form multi-view images of 9 frames.

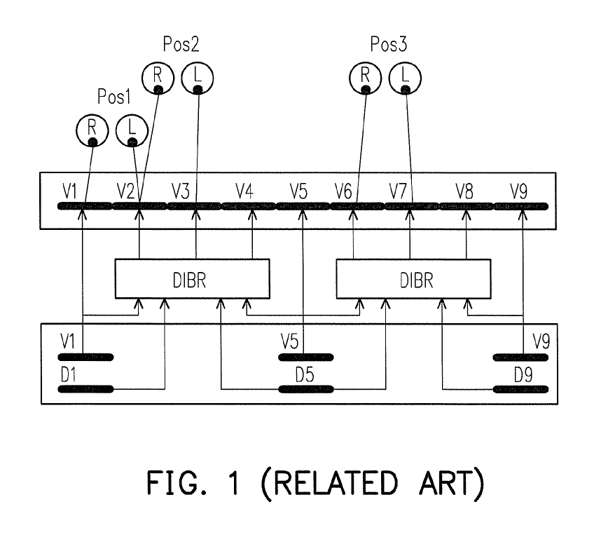

FIG. 2 is a flowchart illustrating a compression method of depth map in a 3D video according to an exemplary embodiment of the disclosure.

FIG. 3 is a block diagram of a compression apparatus of depth map in a 3D video according to an exemplary embodiment of the disclosure.

### DETAILED DESCRIPTION OF DISCLOSED EMBODIMENTS

A depth map of a three-dimensional (3D) video has following characteristics: (1) regarding an area lack of graphic features in a frame, for example, an area with the same color and closed distance, an area without other objects, or an area with a gradually varied distance, etc., when such area is photographed or processed to obtain pixel values of the corresponding depth map, i.e. the depth values, an error result similar to noise is liable to be obtained, i.e. a parallax error is generated; (2) when a texture image and a depth map are used to synthesize a view image, the synthesized image is sensitive to an edge error of an object in the depth map, and the edge error may cause the object edge in the synthesized image to generate broken images. According to the above two points, if the noise of the depth map is suitably eliminated, and significant information of the object edge is maintained, principally, data quantity of a compressed video can be reduced without decreasing quality of the video.

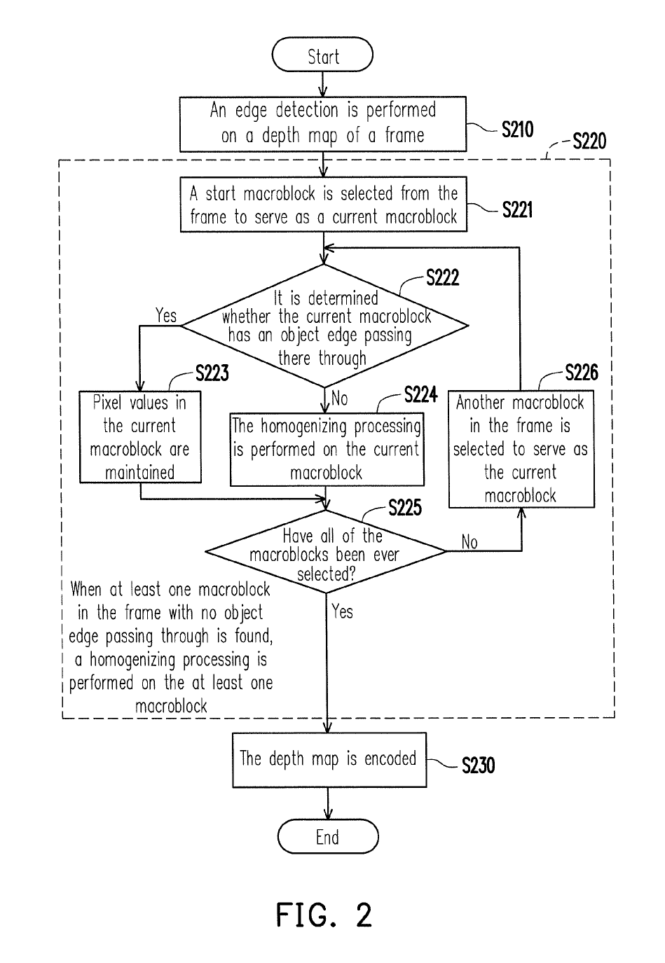

A compression method of depth map in 3D video is disclosed below. Referring to FIG. 2, FIG. 2 is a flowchart illustrating a compression method of depth map in a 3D video according to an exemplary embodiment of the disclosure. In step S210, an edge detection is performed on a depth map of a frame in the 3D video. Data of the 3D video to be processed includes a data stream of texture images and depth maps of a plurality of frames, and the edge detection is first performed on the depth map of one frame. The edge detection method is diversified, which is not limited by the disclosure, for example, a Sobel method, a Prewitt method, a Roberts method, a Laplacian of Gaussion method, a zero-cross method or a Canny method, etc. can be used to perform the edge detection on the depth map.

After the step S210, locations of object edges in the depth map are obtained. In step S220, when at least one macroblock in the frame with no object edge passing through is found, a homogenizing processing is performed on the at least one macroblock. The macroblock is generally composed of 4×4, 8×8, or 16×16 pixels, which is not limited by the disclosure. The depth map of one frame can be divided into a plurality of macroblocks, for example, a depth map of 1024×768 can be divided into 128×92 sub-macroblocks of 8×8, and the number of the macroblocks with no object edge passing there through in a frame can be plural, so that there are many methods for performing the homogenizing processing on all of the macroblocks with no object edge passing there through. Detailed steps of the step S220 are described below.

In step S221, a start macroblock is selected from the frame to serve as a current macroblock. The macroblocks are generally processed in a sequence from the left to the right and from the top to bottom, so that the start macroblock is generally a first macroblock at a top left corner, though the disclosure is not limited thereto, the start macroblock can also be located at other positions, and the processing sequence can also be a Z-shape sequence, etc. In step S222, it is determined whether any object edge passes through the current macroblock. When any object edge passes through the current macroblock, a step S223 is executed, and when no object edge passes through the current macroblock, a step S224 is executed. In the step S223, when the current macroblock has any object edge passing there through, pixel values in the current macroblock are maintained, namely, a depth value of the current macroblock is not changed or not processed, and the present data stream is skipped or directly stored. In the step S224, when no object edge passes through the current macroblock, the homogenizing processing is performed on the current macroblock. The method for homogenizing processing is diversified, a median filter, or a low pass filter such as a Butterworth filter or a Gaussian filter can be used on the current macroblock to filter noise signals, so as to achieve an effect of the homogenizing processing. Moreover, an average can be used to replace the pixel value of each of the pixels in the current macroblock, for example, an arithmetic mean of all pixels in the current macroblock is first calculated, and then the arithmetic mean is used to replace the pixel value of each of the pixels in the current macroblock. However, the disclosure is not limited to the aforementioned method, any homogenizing processing method and any combination of homogenizing processing methods can be used. In step S225, it is determined whether all of the macroblocks have ever been selected, and when there is any macroblock that is not ever selected, a step S226 is executed, by which another macroblock in the frame is selected to serve as the current macroblock, and the step S222 is returned. When all of the macroblocks have been selected, a step S230 is executed. In brief, another macroblock in the frame is selected to serve as the current macroblock, and the steps S222, S223 and S224 are repeated until all of the macroblocks have been selected.

In step S230, the depth map is encoded, and after the depth map processed by the aforementioned steps is compressed and encoded through H.264 or an intra coding of intra pictures of advanced video coding (AVC), or any other relevant 3D video compression and encoding method, a file size thereof is smaller than the data stream compressed and encoded through the intra coding without being processed by the aforementioned steps.

The step S225 is to determine whether all of the macroblocks have been selected, though the disclosure is not limited thereto, and the spirit of the disclosure is also met if only a part of the macroblocks in the frame is selected, and the disclosure is not limited to a situation that all of the macroblocks in the frame have ever been selected.

In another exemplary embodiment, an edge area and a non-edge area of the object in the depth map are first found, and then the homogenizing processing is performed on the macroblocks in the non-edge area. Referring to the flowchart of FIG. 2, in the step S210, by performing the edge detection on the depth map of the frame in the 3D video, an edge area and a non-edge area can be found, where the so-called edge area may include all of the macroblocks having the object edge passing there through, though the disclosure is not limited thereto, and the edge area may include all of the macroblocks having the object edge passing there through and the macroblocks adjacent thereto, or a wider area that takes the macroblock having the object edge passing there through as a center. The non-edge area is a set of the macroblocks in the frame other than the edge area.

In the present exemplary embodiment, the homogenizing processing is performed on the macroblocks in the non-edge area. Therefore, the step S220 is to perform the homogenizing processing on each of the macroblocks in the non-edge area, and the step S222 is to determine whether the current macroblock belongs to the non-edge area, and when the current macroblock belongs to the non-edge area, the homogenizing processing is performed on the current macroblock.

In another exemplary embodiment, the edge area of the object in the depth map is first found, and when the macroblock does not belong to the edge area, the homogenizing processing is performed on the macroblock. Referring to the flowchart of FIG. 2, in the step S210, by performing the edge detection on the depth map of the frame in the 3D video, the edge area can be found, where a definition of the edge area is the same or similar to that of the aforementioned exemplary embodiment. In the present exemplary embodiment, according to the step S220, when at least one macroblock in the frame does not belong to the aforementioned edge area, the homogenizing processing is performed on the macroblock, and the step S222 is to determine whether the current macroblock belongs to the edge area, and when the current macroblock does not belong to the edge area, the homogenizing processing is performed on the current macroblock.

According to the step S230 of the aforementioned method, the whole depth map is compressed and encoded after all of the macroblocks in the frame have ever been selected, though the disclosure is not limited thereto, and the so-called encoding the depth map can also be interpreted as compressing and encoding each of the macroblocks in the depth map, so that such step can be placed before the step S225, and a result thereof does not influence the technical feature of the disclosure.

Another exemplary embodiment of the disclosure provides a computer readable medium storing a program, and when a computer loads and executes the program, the aforementioned compression method is implemented. Another exemplary embodiment of the disclosure provides a computer program product, and when the computer loads and executes the computer program, the aforementioned compression method is implemented.

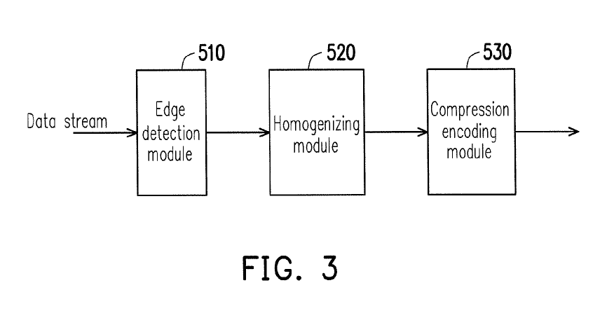

FIG. 3 is a block diagram of a compression apparatus of depth map in a 3D video according to an exemplary embodiment of the disclosure. Referring to FIG. 3, the compression apparatus of FIG. 3 includes an edge detection module 510, a homogenizing module 520, and a compression encoding module 530. The edge detection module 510 performs an edge detection on a depth map of a frame in the 3D video. The homogenizing module 520 is coupled to the edge detection module 510, and when a macroblock in the frame with no object edge passing through is found or the macroblock does not belong to an edge area, the homogenizing module 520 performs a homogenizing processing on the macroblock. The compression encoding module 530 is coupled to the homogenizing module 520 and encodes the homogenized depth map. The operation method and operation principle of the apparatus is the same to the aforementioned method, so that details thereof are not repeated.

In summary, the homogenizing processing is performed on the macroblock in the non-edge area or the macroblock with no object edge passing there through. Therefore, when the depth map is compressed and encoded, the data quantity might be decreased according to the disclosure.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A compression method of depth map in a three-dimensional (3D) video, executed on a compression apparatus of depth map in the 3D video, and the compression method comprising:
performing an edge detection on a depth map of a frame in the 3D video;
when at least one macroblock in the frame with no object edge passing through is found, performing a homogenizing processing on the at least one macroblock; and
encoding the depth map.

2. The compression method of depth map in the 3D video as claimed in claim 1, wherein the step of performing the homogenizing processing on the at least one macroblock comprises:
selecting a start macroblock in the frame to serve as a current macroblock;
determining whether any object edge passes through the current macroblock;
maintaining pixel values in the current macroblock when any object edge passes through the current macroblock;
performing a homogenizing processing on the current macroblock when no object edge passes through the current macroblock; and
selecting another macroblock in the frame to serve as the current macroblock, and repeating the above three steps until all of or a part of the macroblocks in the frame are ever selected.

3. The compression method of depth map in the 3D video as claimed in claim 1, wherein the step of performing the homogenizing processing on the at least one macroblock, comprises:
calculating an average of all pixels of the macroblock; and
using the average to replace a pixel value of each of the pixels in the macroblock.

4. The compression method of depth map in the 3D video as claimed in claim 1, wherein the step of performing the homogenizing processing on the at least one macroblock comprises:
using a median filter, a Butterworth filter or a Gaussian filter to process the at least one macroblock.

5. The compression method of depth map in the 3D video as claimed in claim 1, wherein a method of performing the edge detection comprises a Sobel method, a Prewitt method, a Roberts method, a Laplacian of Gaussion method, a zero-cross method or a Canny method.

6. The compression method of depth map in the 3D video as claimed in claim 1, wherein the edge detection is performed on the depth map to find an edge area and a non-edge area, the edge area comprises all of the macroblocks having the object edge passing there through, and the non-edge area is a set of the macroblocks in the frame other than the edge area, and a step of performing the homogenizing processing on the macroblock with no object edge passing there through comprises:
performing the homogenizing processing on each of the macroblocks in the non-edge area.

7. The compression method of depth map in the 3D video as claimed in claim 6, wherein the step of performing the homogenizing processing on each of the macroblocks in the non-edge area comprises:
selecting a start macroblock in the frame to serve as a current macroblock;
determining whether the current macroblock belongs to the non-edge area;
performing the homogenizing processing on the current macroblock when the current macroblock belongs to the non-edge area; and
selecting another macroblock in the frame to serve as the current macroblock, and repeating the above two steps until all of the macroblocks in the frame are ever selected.

8. The compression method of depth map in the 3D video as claimed in claim 6, wherein the edge area comprises all of the macroblocks having the object edge passing there through and macroblocks adjacent thereto.

9. The compression method of depth map in the 3D video as claimed in claim 6, wherein the edge area comprises a wider area that takes the macroblock having the object edge passing there through as a center.

10. A compression apparatus of depth map in a 3D video, comprising:
an edge detection module, performing an edge detection on a depth map of a frame in the 3D video;
a homogenizing module, coupled to the edge detection module, wherein when a macroblock in the frame with no object edge passing through is found or the macroblock does not belong to an edge area, the homogenizing module performs a homogenizing processing on the macroblock; and
a compression encoding module, coupled to the homogenizing module, and encoding the homogenized depth map.

11. The compression apparatus of depth map in the 3D video as claimed in claim 10, wherein the homogenizing module calculates an average of all pixels of the macroblock, and uses the average to replace a pixel value of each of the pixels in the macroblock.

12. The compression apparatus of depth map in the 3D video as claimed in claim 10, wherein the homogenizing module uses a median filter, a Butterworth filter or a Gaussian filter to process the macroblock.

13. The compression apparatus of depth map in the 3D video as claimed in claim 10, wherein the edge detection module uses a Sobel method, a Prewitt method, a Roberts method, a Laplacian of Gaussion method, a zero-cross method or a Canny method to perform the edge detection.

14. A computer readable medium storing a program, wherein when a computer loads and executes the program, the method as claimed in claims 1 is implemented.

15. A computer program product, wherein when a computer loads and executes the computer program, the method as claimed in claims 1 is implemented.
